(19) United States
(12) Patent Application Publication
(10) Pub. No.: US 2004/0195291 A1
(43) Pub. Date: Oct. 7, 2004

(54) FSW tool

(76) Inventors: Claes-Göran Andersson, Tjaderspelsvagen (SE); Dick R.E. Andrews, Thaxted (GB)

Correspondence Address: Albihns Stockholm, PO Box 5581, Stockholm, S114 85, SE

(21) Appl. No.: 10/476,982

(22) PCT Filed: May 8, 2002
(86) PCT No.: PCT/SE02/00908

(30) Foreign Application Priority Data
May 11, 2001 (SE) 0101663-3

(51) Int. Cl. B23K 20/12

(52) U.S. Cl. 228/2.1

(57) ABSTRACT

The invention resides in a friction stir welding tool comprising a shaft (532) and a tapered probe (504), said probe having a plurality of helically pitched surfaces (512) extending in the direction from the proximal end (530) of the probe to a distal end (531) of the probe, such that the diameter of the probe, in every longitudinal cross-section of the probe (504), diminishes continously from the proximal end (530) to the distal end (531) of the probe.

### FIELD OF THE INVENTION

The present invention relates to friction stir welding tools, more particularly it relates to an improved probe.

### DESCRIPTION OF RELATED ART

Friction stir welding represents a relatively new welding technique. The technique has been developed for welding metals and alloys which have proved difficult to join using conventional fusion welding techniques on account of e.g. thickness of the metal/alloy to be joined or simply metals/alloys that are difficult to weld and require special shielding gases. Flaws that are normally associated with fusion welding such as porosity or solidification cracking may be avoided as a weld cools down.

Generally one may say for friction stir welding that the thickness of the metal/alloy to be joined increases it becomes more difficult to achieve a weld of good integrity.

In friction stir welding a rotating shouldered cylindrical tool, as shown in FIG. 1a, is used to create mechanical friction in the metal in contact with the rapidly rotating cylindrical tool. The mechanical friction softens the metal in contact with the rotating tool due to the heat evolved by the friction between the tool and the metal to be joined.

The probe is made from a material harder than the work piece material and is caused to enter the joint region and opposed portions of the workpieces, as shown in FIG. 2b, on either side of the joint region while causing a relative cyclic movement, e.g. a rotational or reciprocal movement between the probe and the workpieces whereby frictional heat is generated to cause the opposed portions of the workpieces to be softened. The probe in creating a weld will be moved in the direction of the joint region. As the probe moves the softened metal/alloy will flow around it and consolidate behind it and thus join the workpieces together.

Examples of friction stir welding are described in EP-B-0615480 and WO 95/26254. Examples of tools are described in e.g. GB-A-2306366, WO 99/52669, and W099/58288.

The tools used for friction stir welding comprises a cylindrical or tapered probe projecting from a larger diameter flat or domed shoulder, as shown in FIG. 1b. The depth to width ration of the probe length versus its normal diameter is preferably in the order of 1:1 and the ratioof the shoulder diameter to the probe length is of the order of 3:1 or 4:1, as first disclosed in EP-B-0615480 for welding 3 mm thick and 6 mm thick sheets and plates in an aluminum alloy.

For welding thicker plates of 15 mm up to 25 mm in a single pass, the thickness varying between 15 to 25 mm probes of the type having a 1:1 length/diameter could be used, however these probes tend to displace an excessive amount of material. As the plates grow thicker scaled-up probes of know simple parallel probe type will displace increasing amounts of material and trials have shown that this is not a recommended way of solving the problem. However, the welding of thicker materials will necessitate a higher input of pressure put on the probe indicating that it may be a problem to lengthen the probe without making it wider in order to maintain strength.

One crucial point in the process of joining work pieces using friction stir welding when it comes to work pieces of greater dimensions is the “plunge sequence”, i.e. the start of the welding process when the probe is lowered into the joint line. One of the problems experienced during the plunge sequence is that much of the heat generated is rapidly conducted away from the weld zone through the bulk of the copper causing the tool to lock and then shear off. This is particularly true when tool probes are manufactured from alloys which have limited ductility such as cemented carbides or ceramics.

A further problem encountered when attempting to weld thicker workpieces of approximately 50 mm thickness are voids created in the weld in the proximity of the proximal end of the probe close to the surface, probably created by non-uniform flow around the used probe. These voids may be seen on the advancing side near the top face of the weld. (See FIG. 3b and accompanying text below.)

It has commonly been assumed, when welding thinner workpieces that variation of the tool speed, or different rotation speed for the shoulder and the probe are good methods for controlling the heat input to the weld zone. However it has been indicated that it may also be necessary to regulate the temperature of the material/probe in order to accomplish a good function in the welding, when increasing the dimensions of the probe and the workpieces to be joined.

Our work has indicated that lowering the rotational speed of the probe below 400 rev/min increases the torque experienced by the probe. This means that the larger the torque the greater the dimensions of the probe has to be in order to avoid fracture of the probe.

However increasing the rotation speed above 400 rev/min rapidly increases the temperature of the top surface of the work pieces causing that to become extremely soft before the underlying copper becomes sufficiently soften to for welding to take place. This situation may cause the shoulder of the tool to penetrate or plunge over an excessive distance into the softened top surface layer.

Accordingly, it is an object of the invention to provide a tool for friction stir welding which is capable of welding workpieces having a greater thickness than heretofore attempted, i.e. welds of a thickness amounting to approximately 50 mm and more.

It is also an object to provide a tool which can withstand the forces necessary to make welds of this dimension.

It is a further object to provide a tool which when used will keep the right temperature, not too low and not to high in the material to be welded and which will also protect the tool from overheating.

### SUMMARY OF THE INVENTION

The present invention discloses a stir welding probe for joining by friction weld stirring workpieces exhibiting thickness up to app. 50 mm or more. The present invention also discloses a probe capable of preventing voids to be formed in the finished weld. The tool is of a helically wound design having special features to accomplish the above.

According to the invention the objects are accomplished by a friction stir welding tool comprising a shaft and a tapered probe, said probe having a plurality of helically pitched surfaces extending in the direction from a proximal end of the probe to a distal end of the probe, such that the diameter of the probe, in every longitudinal cross-section of the probe, diminishes continuously from the proximal end to the distal end of the probe.

According to the invention further objects are accomplished by a friction stir welding tool in which probe each said helically pitched surfaces is connected to an adjacent helically pitched surfaces of the probe by helically arranged surfaces, the longitudinal direction of which is essentially co-planar to an axis of rotation of the probe.

Further objects are solved according to the invention by the probe exhibiting leading helical ridges formed by the connection line between each helically arranged surfaces and the, in the distal direction, adjoining helically arranged surfaces.

Further objects are solved according to the invention by a probe in which every diameter, in every longitudinal cross-section of the probe, diminishes without ever increasing when moving from the proximal to the distal end of the probe.

Further objects are solved according to the invention by a probe in which the helically pitched surfaces have an essentially concave form.

Still further objects are solved according to the invention by a probe exhibiting a probe tapering angle up to 45°, preferably between 5° to 25°, most preferred 10° to 20°.

The expression “diminishes continuously” should be understood such that the diameter never increases, but may remain constant for a shorter distance, such a distance being shorter than the distance between two adjacent pitched surfaces.

A probe formed in accordance with the invention has a number of advantages. Firstly, it leaves no room for the plasticized material to be welded, to aggregate after a trailing edge in a probe having a fluted design. Also the form of the probe according to the invention provides for a better flow path around the probe as it moves along the weld to be.

Providing a better flow path also assists in avoiding breakage of the probe due to excessive forces on the probe.

In order to provide a consistent and reproducible weld microstructure and reliable tool probe performance cooling of the probe may be used. This requires monitoring equipment, means for registering the temperature of the probe, possibly on several points of the probe length in order to provide an as uniform heat as possible along the probe when used in welding.

### BRIEF DESCRIPTION OF THE DRAWINGS

FIG. 1a shows a known friction stir welding probe and shoulder;

FIG. 1b shows the method of friction stir welding;

FIG. 2a shows a prior art friction stir welding tool exhibiting flutes;

FIG. 2b shows the prior art tool according to FIG. 2a in

FIG. 3a a scaled up probe to be used with 50 mm copper;

FIG. 3b a section through a weld disclosing a void

FIG. 4a illustrates the problem of voids in the weld

FIG. 4b illustrates such a void in the weld

FIG. 5 shows an embodiment of the friction stir welding probe according to the invention

FIG. 6 illustrates the scaling-up of a probe to be used with different thickness' of the workpieces and some selected probe tapering angles;

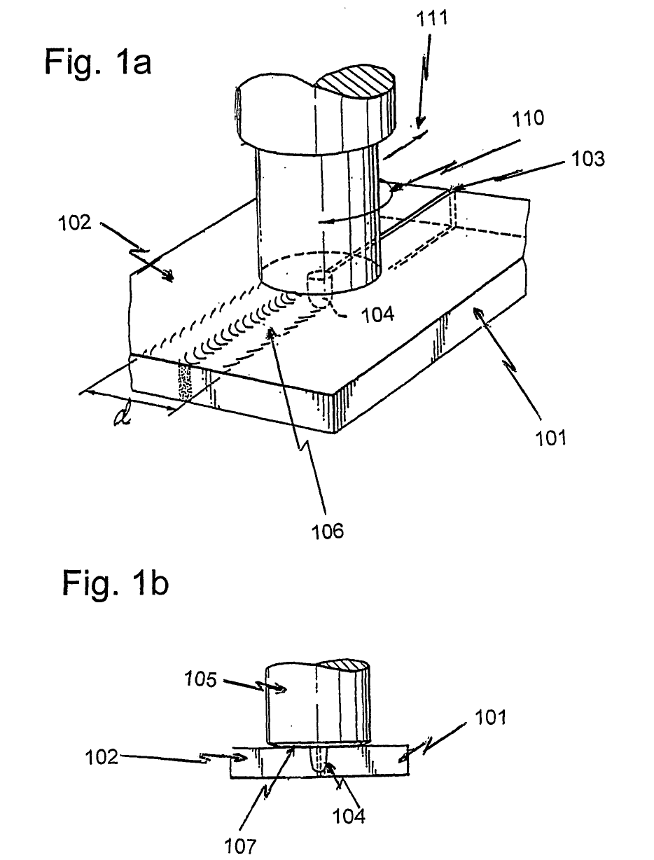

In FIG. 1a is shown the manner in which friction stir welding is accomplished according to the art and also a probe according to prior art. A pair of aluminum plates 101 and 102 are shown abutting each other at a joint line 103, together with a nonconsumable probe 104 of a material which is harder than the material of the workpieces. The probe 104 is pressed into the plates in the vicinity of the joint line but does not extend completely through the thickness of the materials being joined. The depth of penetration is controlled by the shoulder 107 (shown in FIG. 1b) making contact with the workpieces. The width “d” of the contact zone 106 between the shoulder and the workpieces is shown as a series of semi-circular ripples on the upper surface of the pieces. The direction of the rotation of the tool is shown as an arrow 110 and the direction of the movement of the probe along the joint line is indicated by the arrow 111.

FIG. 1b shows a schematical side view of the workpieces 101, 102, and the probe 104. The shoulder 107 which controls the depth of penetration in the joint line is also shown. The probe has a blunt normally spherical tip which assists in the penetration until the penetration is arrested by contact between the shoulder 107 and the workpieces 101 and 102.

It may be noted that the with of the contact zone 106, is of the order of at least three, four times the thickness of the workpieces. Also the nominal maximum diameter of the slightly tapered cylindrical probe is of the same order as the thickness of the workpieces.

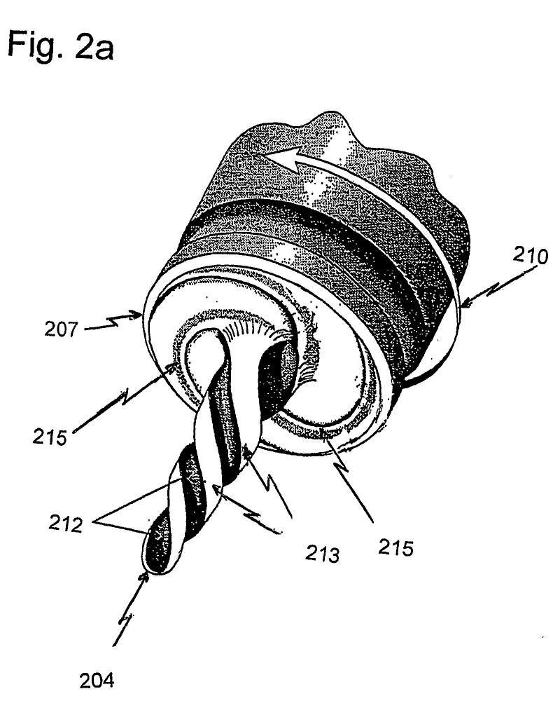

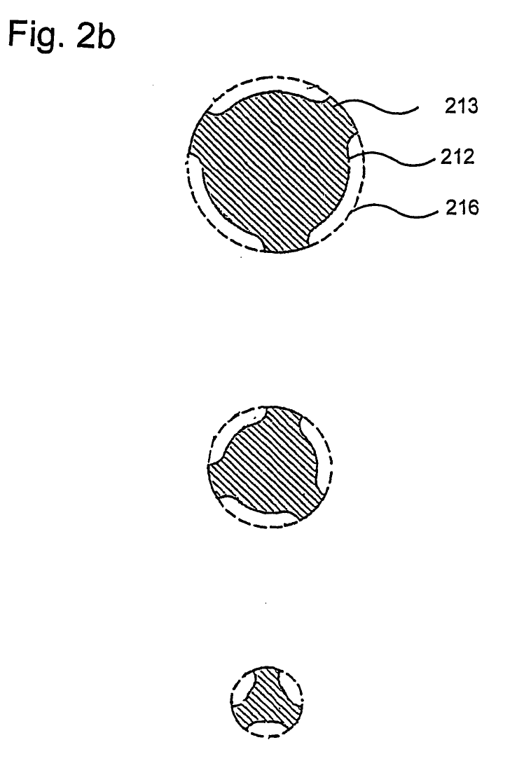

In FIG. 2a is shown a known probe 204 for deep section butt welding. The probe exhibits a tapered form narrower at the most distal part of the probe. The probe 204 is scalloped to give deep spiral like projections 212, which execute approximately one complete turn in the length of the probe and in which three ridges 213 are provided as in a multi-start arrangement to define three groves 212 or flutes. The ridges 213 or lands provided between the flutes are of considerable width. The helix angle that the ridges make with the axis of the probe is of the order of 45° or less. This probe not only provides a circumferential working of the material but also provides a motion of the plasticized material in the direction downward counted from the shoulder 207.

The probe 204 has at its proximal end a shoulder 207. The shoulder 207 exhibits spiral ridges 215. These spiral ridges act in an inward direction with the given rotation to reduce the tendency of plasticized material to escape, especially on the surface of the workpieces. The ridges may e.g. also run parallel to the circumference of the shoulder.

In FIG. 2b the probe 204 is shown a section. The three ridges/lands 213 and the three grooves/flutes 212 are indicated.

However, the probe shown in FIG. 2 has shown some disadvantages when attempting to make friction stir welds in copper workpieces of considerable thickness, e.g. approximately 50 mm.

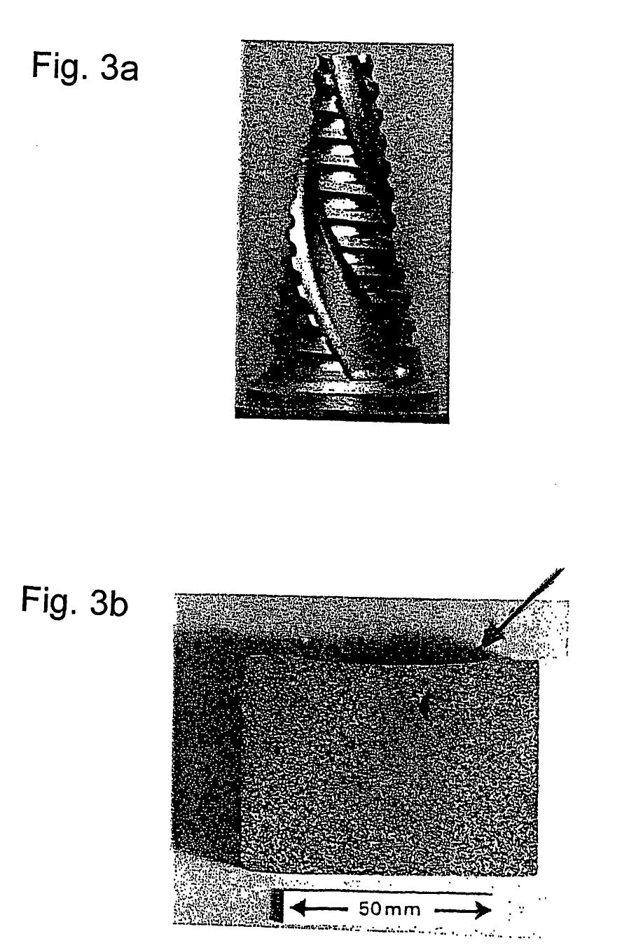

In FIG. 3a is shown a scaled up three-fluted probe to be used with 50 mm copper. It was shown that this type of probe could give rise to voids in the finished weld as shown in FIG. 3b. FIG. 3b shows a section through a weld disclosing a void at the arrow

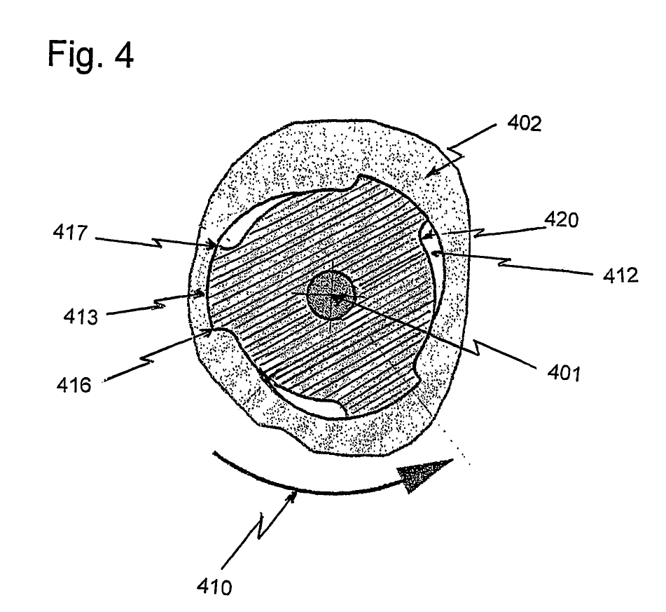

In FIG. 4 is shown schematically how voids may form in the finished weld when welding, e.g. copper using a probe of similar design to the one in FIG. 3a. The three-fluted probe is shown in section surrounded by plasticized copper 402. Tip 401 of the probe is indicated. The flutes 412 in this probe is formed essentially by three protruding lands 413 having symmetrical edges 416 and 417. Depending on the rotation of the probe as shown the leading edge will be 416 and the trailing edge will be edge 417. As the probe is rotated in the direction of the arrow 410 the plasticized copper does not fill the cavity 420 behind the trailing edge 404 of the land, or looking at it the other way, a void 420 is created after the leading edge 404 of the flute. These created voids in the plasticized material may, when the weld has cooled remain as a fault in the structure weakening the weld. It is therefore important to provide a probe which does not leave any voids in the material during the process of friction stir welding.

### DETAILED DESCRIPTION OF A PREFERRED EMBODIMENT OF THE INVENTION

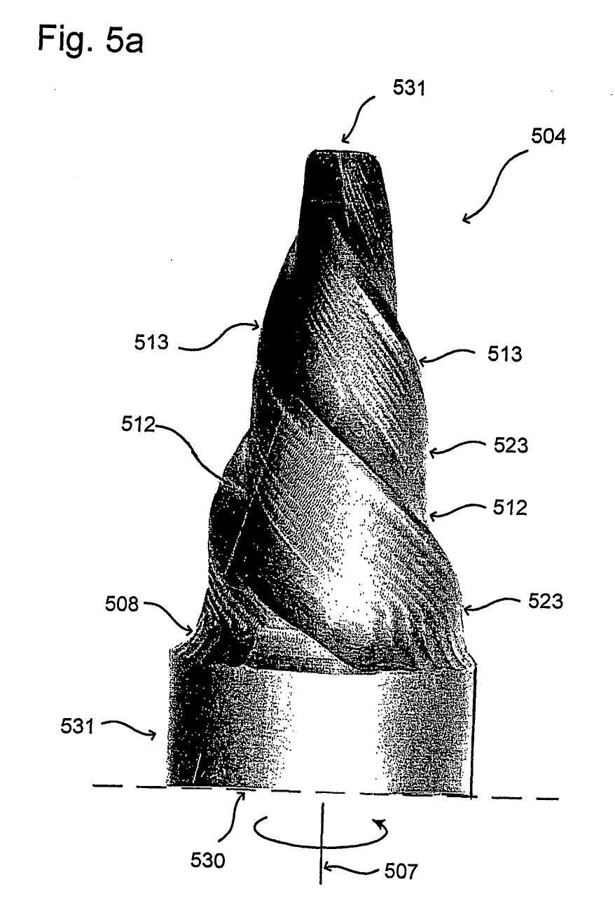

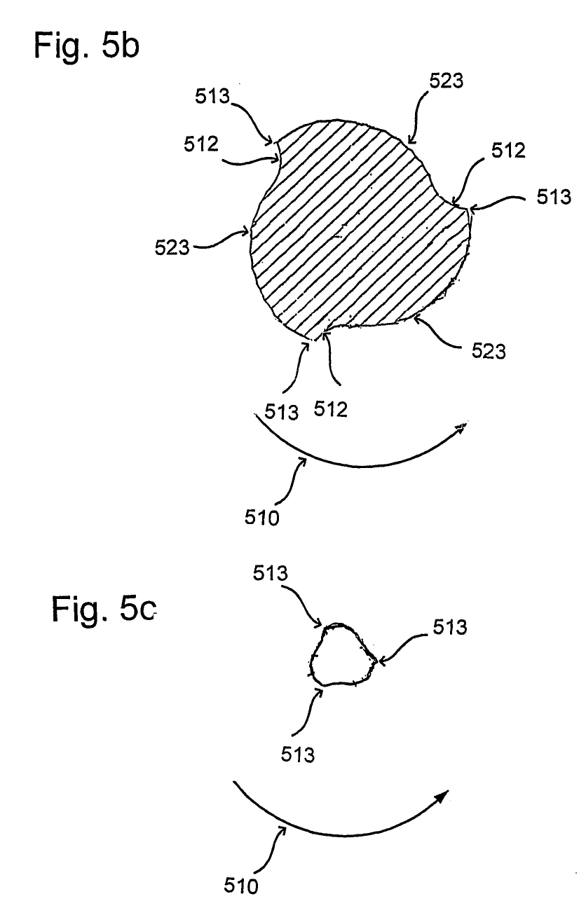

In FIG. 5a a probe 504 according to the invention is shown. The probe is adapted to be fit into a holder (not shown) by providing a flat portion of the shaft of the probe. A shoulder (not shown) to be used in connection with the probe may be provided on the holder, alternatively on the probe itself.

The probe and the holder including an appropriate shoulder may of course be manufactured in one piece as the man skilled in the art will appreciate.

The probe 504 as shown exhibits three helically pitched surfaces 512. However, the form of these surfaces differ essentially from the flutes shown in the prior art probes. The lands or ridges 513 according to the prior art have become thin ridges 513, the surface of which is essentially parallel with the axis of rotation 407 of the probe and a land 523 between each ridge 513 and the adjacent helically pitched surface 512 is also essentially parallel with the axis of rotation 507 of the probe. The lands 523 exhibit thin helically wound parallel grooves 508 parallel to the ridges 506. These groves or thin ridges are a result of the manufacturing process but also seem to play a part in the friction stir welding as an additional friction creating tool. However, the probe may be polished and still function satisfactorily.

Pressure relief means 531 may be provided at the proximal end of at least one of the leading helical ridges 513 such as to provide a bypass adjacent to a shoulder (not shown) to be provided at the proximal end of the tapering part of the probe.

Two sections, perpendicular to the longitudinal axis of the probe, through the probe according to FIG. 5a are shown in FIG. 5b and FIG. 5c, respectively. FIG. 5b represents a section in at the proximal end of the probe and FIG. 5c represents a section near the distal end of the probe. The ridges 513, the lands 523, and the surfaces 512 are indicated in the figures. The direction of the rotation of the probe is indicated with an arrow 510.

Considering the sections shown in FIGS. 5b and 5c one may understand why the probe according to the invention will not cause any unnecessary voids in the finished weld. The probe according to the invention leaves no room for forming a void in the plasticized metal behind a the trailing edge of the ridge 513, The trailing edge of the ridge has essentially been eliminated.

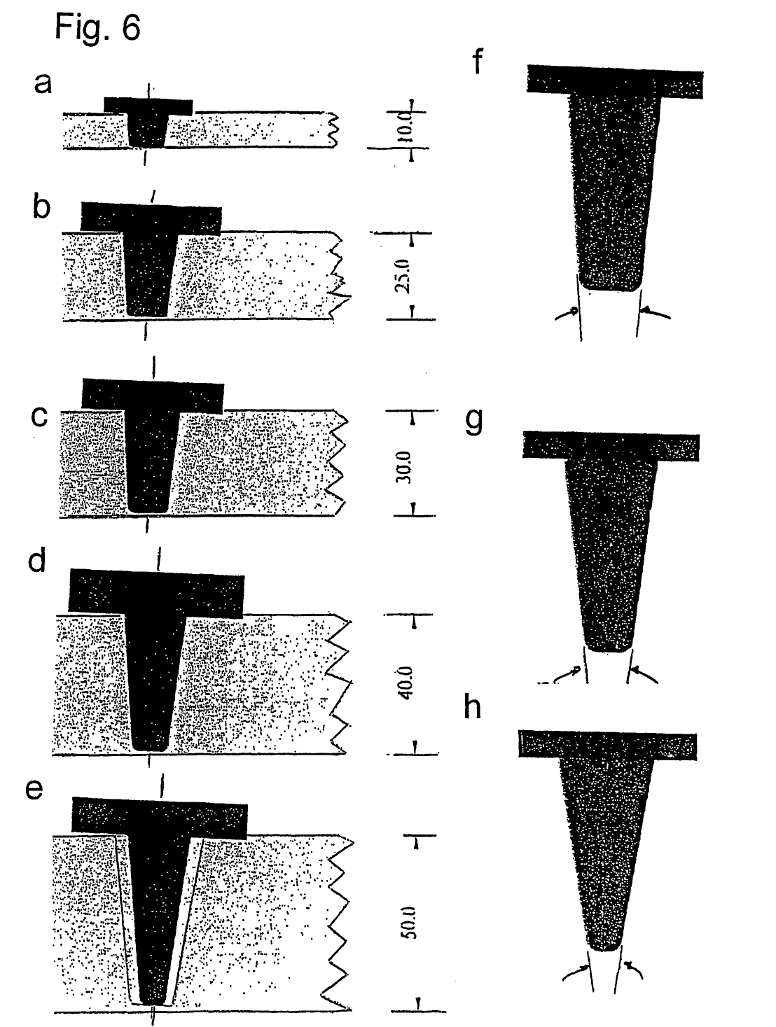

In FIG. 6 is finally shown examples of the relation between the shoulder and different lengths of probes to be used with work pieces of varying thickness'. In FIGS. 6a -6e typical probe sizes for 10 mm up to 50 mm are shown. In FIGS. 6f-6h are shown tapering angles of 10, 14 and 18°.

The description of the above preferred embodiment should be understood as one of several embodiments within the scope of the invention as defined by the appended claims.

1. A friction stir welding tool comprising a shaft (532) and a tapered probe (504), said probe having a plurality of helically pitched surfaces (512) extending in the direction from the proximal end (530) of the probe to a distal end (531) of the probe, such that the diameter of the probe, in every longitudinal cross-section of the probe (504), diminishes from the proximal end (530) to the distal end (531) of the probe, and that each of said helically pitched surfaces (512) is connected to an adjacent helically pitched surfaces (512) of the probe (504) by helically arranged surfaces (523), the longitudinal direction of which is essentially co-planar to an axis of rotation (507) of the probe.

2. A tool according to claim 1 or 2, characterized in that leading helical ridges (513) are formed by the connection line between each helically arranged surfaces (523) and the, in the distal direction, adjoining helically arranged surfaces (523).

3. A tool according to any of the preceding claims, characterized in that every diameter diminishes or remains essentially constant when moving from the proximal (530) to the distal end (531) of the probe (504).

4. A tool according to any of the preceding claims, characterized in that the helically pitched surfaces (512) have an essentially concave form.

5. A tool according to any of the preceding claims, characterized by a probe tapering angle up to 45°, preferably between 5° to 25°, most preferred 10° to 20°.

6. A tool according to any of the preceding claims, characterized by means for monitoring the temperature of the probe and means for cooling of the same.

7. A tool according any of the preceding claims, characterized by pressure relief means (531) formed at the proximal end of at least one of the leading helical ridges such as to provide a bypass adjacent to a shoulder to be provided at the proximal end of the tapering part of the probe.
